(19) United States
(12) Patent Application Publication
(10) Pub. No.: US 2007/0146553 A1
(43) Pub. Date: Jun. 28, 2007

(54) RECEIVING CIRCUIT, RECEIVING APPARATUS, AND RECEIVING METHOD

(75) Inventors: Sachiko MORI, Osaka (JP); Yasuo OBA, Osaka (JP); Makoto IKUMA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/616,356

(22) Filed: Dec. 27, 2006

(30) Foreign Application Priority Data
Dec. 28, 2005 (JP) 2005/378906

(51) Int. Cl. H04N 5/50

(52) U.S. Cl. 348/731

(57) ABSTRACT

A receiving circuit according to the present invention includes a phase-locked loop circuit which outputs an oscillation signal synchronized with a phase of a modulation signal modulated by a video signal, a video signal detector which synchronously detects the modulation signal using the oscillation signal, so as to output the video signal, and a frequency detection circuit which determines whether the frequency of the oscillation signal falls within a predetermined range, so as to output a frequency detection signal indicating whether the phase-locked loop circuit is in a locked state. The receiving circuit controls the phaselocked loop circuit using the frequency detection signal

### BACKGROUND OF THE INVENTION

(1) Field of the Invention

The present invention relates to a circuit which processes a video intermediate-frequency signal using a phase-locked loop (to be referred to as a PLL hereinafter), and particularly to a receiving circuit which can obtain a stable video detection output even when an input signal is in an overmodulated state. For example, the receiving circuit is used in a field of a television receiver and a video player having a television tuner built therein.

(2) Description of the Related Art

For example, in an intermediate-frequency stage of a television set or the like, a synchronous detection circuit is used to detect an amplitude modulation wave (for example, Laid-Open Japanese Patent Application No. 03-44280 and Japanese Laid-Open Patent Application No. 05-244533). FIG. 1 is a block diagram showing a receiving apparatus including a video intermediate-frequency signal processing circuit of a conventional PLL synchronous detecting scheme. As shown in FIG. 1, a conventional television receiver mainly includes an antenna 10, a tuner circuit 100 which selects a desired channel frequency from a television high-frequency signal received by the antenna 10 to convert the channel frequency into a video intermediate-frequency signal, and a video intermediate-frequency signal processing circuit 101 which detects a video signal from the video intermediate-frequency signal.

An operation of the receiving apparatus shown in FIG. 1 will be described with a central focus on the conventional video intermediate-frequency signal processing circuit 101. The television high-frequency signal received by the antenna 10 is amplified by a high-frequency amplifier 11, mixed with a local oscillation signal outputted from a local oscillator 13 by a mixer 12, and converted into a video intermediate-frequency signal (to be referred to as a VIF signal hereinafter) having a video carrier wave frequency (in Japan, 58.75 MHz). The high-frequency amplifier 11 has an RFAGC function and operates to make a video detection output constant. The RFAGC function is omitted in FIG. 1.

A VIF (signal a) passing through a bandpass filter (in general, an SAW filter) 14 for an intermediate-frequency signal is amplified to a predetermined level by a video intermediate-frequency amplifier 20 signal b, and the resultant signal is inputted to a video signal detector (to be referred to as a VIF detector hereinafter) 21.

An output signal b1 from the video intermediate-frequency amplifier 20 is also inputted to the PLL circuit 102 constituted by a phase detector 25, a low-pass filter (to be referred to as an LPF hereinafter) 26, a voltage control oscillator (to be referred to as a VCO hereinafter) 27, and a phase shifter 28. The output signal b from the VIF amplifier 20 and an output signal fi from the phase shifter 28 are inputted to the phase detector 25 and compared with each other in phase. A signal which is in proportion to the phase difference is output from the phase detector 25. An output signal g from the phase detector 25 is smoothed by the low-pass filter 26 and converted into a DC voltage signal h. The VCO 27 outputs a signal of an oscillation frequency depending on a control voltage output from the low-pass filter 26 signal d. The phase shifter 28 shifts the phase of an output signal d from the VCO 27 and outputs the signal such that a phase difference between the signal e and the signal f is 90°. The signal e and the signal f are inputted to the VIF detector 21 and the phase detector 25, respectively.

In the VIF detector 21, the output signal b from the VIF amplifier 20 and the output signal e are inputted, both the input signals are multiplied by each other, and the result, from which a high-frequency component is subtracted, is outputted signal c. When the PLL circuit 102 is locked, the output e from the phase shifter 28 is given to the VIF detector 21 such that the output has a frequency and a phase which are equal to those of a video carrier wave of a VIF signal a. The VIF detector 21 synchronously detects an output from the amplifier 20 based on the signal in order to output a video detection output c.

The video detection output c is externally outputted from a video signal output terminal 22 and fed back to an internal ACC circuit 29 and an internal lock detection circuit 30. The AGC circuit 29 detects a level of the video detection output c to control a gain of the VIF amplifier 20 and holds an output b from the VIF amplifier 20 to a predetermined level. On the other hand, the lock detection circuit 30 determines, based on the video detection output c, whether the PLL circuit 102 is locked or unlocked signal j to control a time constant of the LPF 26. More specifically, in the locked state, the time constant is increased to decrease a response speed, and the LPF 26 is controlled such that the LPF 26 does not easily respond to noise or phase distortion or the like held by the VIF signal. On the other hand, in the unlocked state, the time constant of the LPF 26 is decreased to increase the response speed, so that a capture range of the PLL is widened.

On the other hand, in recent years, in order to excessively amplify a television signal transmitted from a broadcast station which has a modulated amplitude, broadcasting may be performed in an overmodulated state in which a degree of amplitude modulation is 100% or more. In a device in which an RF converter which causes a video device to make a television high-frequency signal is built, an overmodulated state may be set when the television high-frequency signal is made. When a VIF signal a transmitted by these operations is demodulated by the video intermediate-frequency signal processing circuit 101, the phase of a carrier wave of the VIF signal a is inverted. Since the PLL circuit 102 operates such that the phase of the output e from the phase shifter 28 is synchronized with the phase of the inverted signal, the PLL circuit 102 is disadvantageous in that the PLL circuit 102 cannot correctly reproduce the carrier wave.

In order to overcome this disadvantage, there is a video intermediate-frequency signal processing circuit which employs a sampling PLL synchronous detection scheme as described in Japanese Laid-Open Patent Application No. 03-44280 or the like. In the sampling PLL synchronous detection scheme, a phase comparison output g is supplied to the VCO 27 for a predetermined period, and an output from the VCO 27 has a predetermined phase without performing PLL control in the other period. Therefore, when the period in which the PLL is operated is the same as the period (for example, a horizontal synchronous signal period) in which overmodulation is not performed, the VCO output has a constant phase without operating the PLL in the overmodulated state, locking to an inverted phase occurring in a video intermediate-frequency signal processing circuit of the continuous PLL synchronous detection scheme shown in FIG. 1 can be prevented.

FIG. 2 shows an example of a video intermediate-frequency signal processing circuit achieved by the conventional sampling PLL synchronous detection scheme. In this circuit, to a phase detector 25′, in addition to an output b from the VIF amplifier 20 and an output f from the phase shifter 28, an output l from a modulation degree detection circuit 32, an output k from a electric field intensity detection circuit 31, and an output j from a lock detection circuit 30 are inputted. The modulation degree detection circuit 32 compares a voltage of a video detection output c changing with time with a reference voltage VMTH to detect a period in which a high degree of modulation is obtained and to output a modulation degree detection signal l. The electric field intensity detection circuit 31 compares a signal of an AGC output i from the AGC circuit 29 with a certain voltage to detect whether the VIF signal is a weak electric field input or an intermediate/strong electric field input at which the AGC circuit operates and outputs an electric field intensity detection signal k. Based on the three output signals j, k, and l, a state of the PLL circuit 102 is switched to any one of a state in which the loop is closed (to be referred to as a closed-loop state hereinafter) and a state in which the loop is open (to be referred to as an open-loop state hereinafter). In the closed-loop state, the output b from the VIF amplifier 20 and the output f from the phase shifter 28 are compared in phase by the phase detector 25′. A control voltage signal h obtained by smoothing a phase detection output g′ oscillates the VCO 27. More specifically, the closed-loop state is the same state as that of the video intermediate-frequency signal processing circuit of the conventional continuous PLL synchronous detection scheme. In the open-loop state, the phase detector 25′ outputs a phase detection output g′ outputted in the immediately previous closed-loop state, and the VCO 27 holds an oscillation frequency and a phase obtained immediately before.

FIG. 3 shows states of the detection signals j, k, and l and the PLL circuit 102 in operation modes n the video intermediate-frequency signal processing circuit 101 of the sampling PLL synchronous detection scheme. In the intermediate/strong electric field input state in which the AGC circuit operates in a locked state, the PLL circuit 102 repeats closing/opening operations of the loop depending on a result obtained by checking whether the video detection output c is higher or lower than the reference voltage VMTH (3-3, 3-4). Periods T2 and T4 in which the video detection output c is higher than the reference voltage VMTH in FIG. 11, i.e., in a period in which a degree of modulating is high and a video signal has a high luminance level, the PLL circuit 102 is set in the closed-loop state, an output immediately before the open-loop state is set is held as the output d from the VCO 27 (3-4). On the other hand, in periods T1, T3, and T5 in which the video detection output c is lower than the reference voltage VMTH in FIG. 11, i.e., in a period in which a video signal has a low luminance level, the PLL circuit 102 is set in the closed-loop state, and the output d from the VCO 27 changed in accordance with the output b from the VIF amplifier 20 (3-3).

On the other hand, in an unlocked state (3-1) and a weak electric field input state (3-2), a state of the PLL circuit 102 is not switched to the closed-loop state or the open-loop state, the PLL circuit 102 is always set in the closed-loop state, and the same capture response as that obtained in the conventional art can be obtained.

FIG. 4 shows a configuration of the lock detection circuit 30 which determines whether the PLL circuit 102 is in a locked state or an unlocked state based on the video detection output c. The video detection output c is inputted to a smoothing circuit 40 and smoothed, and an average level signal p of the video detection output c is given to a comparator 41. The comparator 41 compares a reference voltage Vref with the output signal p from the smoothing circuit 40 to output the result signal j.

In the configuration as shown in FIG. 4, the operation will be described below with reference to waveform charts in FIGS. 5A to 5C. FIG. 5A shows a case in which the PLL circuit 102 is in an unlocked state, FIG. 5B shows a case in which the PLL circuit 102 is in a locked state when a normal modulation input is performed, and FIG. 5C shows a case in which the PLL circuit 102 is in a locked state when an overmodulation input is performed. Each of FIGS. 5A to 5C shows a relationship between the video detection output c, the average level Vp which is an output from the smoothing circuit 40, and the reference voltage Vref in the comparator 41 in the corresponding case.

When the PLL circuit 102 is in the unlocked state, as shown in FIG. 5a, the video detection output c is a beat-like signal. In this case, when the signal is caused to pass through the smoothing circuit 40, a signal having a relatively high voltage almost equal to a no-signal potential V0 appears as the average level Vp. Therefore, since the average level Vp is higher than the reference voltage Vref, as the signal j, a signal indicating that the PLL circuit 102 is in an unlocked state is outputted.

On the other hand, in a normal modulation state, when the PLL circuit 102 is in a locked state, the video detection output c is the same as a video signal. This signal is caused to pass through the smoothing circuit 40, a signal having a relatively low voltage appears as the average level Vp. Therefore, since the average level Vp is lower than the reference voltage Vref, as the signal j, a signal indicating that the PLL circuit 102 is in a locked state is outputted.

### SUMMARY OF THE INVENTION

However, the conventional video intermediate-frequency signal processing circuit 101 compares the average level Vp obtained by causing the video detection output c to pass through the smoothing circuit 40 with the reference voltage Vref to determine whether the PLL circuit 102 is in a locked state or an unlocked state, and, based on the determined signal, the loop of the PLL circuit 102 is opened or closed. For this reason, the video intermediate-frequency signal processing circuit 101 has the following three problems.

As a problem (1), a lock detection circuit erroneously makes a determination when a VIF signal is overmodulated disadvantageously. As shown in FIG. 5C, when the VIF signal is overmodulated, a high-level vide signal is outputted as the video detection output c when the PLL circuit 102 is locked. Therefore, when the video detection signal c is smoothed through the smoothing circuit 40, the average level Vp which is an output from the smoothing circuit 40 shifts to a level higher than that in a normal modulation state and exceeds the reference voltage Vref. As a result, it is determined that the average level Vp is higher than the reference voltage Vref, i.e., the PLL circuit 102 is in an unlocked state. The result is outputted as the signal j. When it is determined that the PLL circuit 102 is in the unlocked state, a state of the PLL circuit 102 is not switched to the open-loop state or the closed-loop state regardless of an overmodulated VIF signal, and the PLL circuit 102 is always set in the closed-loop state. As a result, a correct video detection output cannot be obtained (signal C′ in FIG. 5).

As a problem (2), even though the VIF signal has a normal degree of modulation (87.5%), the lock detection circuit erroneously makes a determination due to a video pattern. For example, a 100% white video pattern has the average level Vp of the video detection output c higher than that of a black video pattern. Depending on set values of the reference voltage Vref, it is determined that the average level Vp is higher than the reference voltage Vref, and it is erroneously determined that the PLL circuit 102 is in an unlocked state. As a result, a time constant of the LPF 26 of the PLL circuit 102 decreases, and audio buzz, beat, and the like occur to deteriorate video characteristics and audio characteristics. Furthermore, the average level Vp of the video detection output c in the unlocked state (FIG. 5A) is easily affected by fluctuations in divergence of a circuit element, an environmental temperature, a power supply voltage, the presence/absence of a color signal, and an intensity of an audio signal (PS ratio). For this reason, when the reference voltage Vref is set at a low level in consideration of these conditions, a locked state is easily erroneously determined in an unlocked state. When the reference voltage Vref is set at a high level, a locked state is erroneously determined in an unlocked state.

As a problem (3), since the frequency of a horizontal synchronous signal of the video detection output c is relatively low (15.7 kHz), the smoothing circuit 40 which outputs an average level signal p requires a large capacitor. When this capacitor is built in a semiconductor integrated circuit, a mask area increases. On the other hand, the capacitor is externally arranged, the number of pins increases. In any case, an increase in cost is caused.

The present invention is to solve the above conventional problems, and has as object to provide a receiving circuit which can correctly receives a video image for any video pattern even though a degree of video modulation of a VIF signal exceeds 100% and which processes a video intermediate-frequency signal without increasing a circuit scale.

In order to solve the problem, the receiving circuit according to the present invention includes: a phase-locked loop circuit which outputs an oscillation signal synchronized with a phase of a modulation signal modulated by a video signal; a video signal detector which synchronously detects the modulation signal using the oscillation signal, so as to output the video signal; and a frequency detection circuit which determines whether or not the frequency of the oscillation signal falls within a predetermined range to output a frequency detection signal that indicates whether or not the phase-locked loop circuit is in a locked state, wherein the phase-locked loop circuit is controlled by the frequency detection signal.

According to this configuration, the determination of a locked/unlocked state of the phase-locked loop circuit is performed based on the oscillation signal outputted from the phase-locked loop circuit but the video signal. More specifically, the determination of the locked/unlocked state is performed by checking whether the frequency of the oscillation signal outputted from the phase-locked loop circuit falls within the predetermined range. For this reason, even though the video signal is overmodulated, or even though a high-luminance image having a white pattern is used, an erroneous determination is advantageously prevented. Furthermore, since the video signal need not he smoothed to determine the locked/unlocked state, no capacitor is required, a circuit area can be reduced, or the number of pins to connect an external capacitor is advantageously prevented from increasing.

The phase-locked loop circuit may include: a voltage control oscillator which outputs the oscillation signal; a phase detector which outputs a signal indicating a phase difference between the modulation signal and the oscillation signal; a low-pass filter which smooths the signal indicating the phase difference, and outputs the smoothed signal as a control voltage to the voltage control oscillator; and a switch circuit which opens and closes a loop formed by the voltage control oscillator, the phase detector, and the low-pass filter, wherein the switch circuit may open and close the loop based on the frequency detection signal.

With this configuration, since a locked/unlocked state is not erroneously determined, opening/closing of the loop by the switch circuit can be reliably realized, and the receiving circuit can stably output a video signal.

The phase-locked loop circuit may include: a voltage control oscillator which outputs the oscillation signal; a phase detector which detects a phase difference between the modulation signal and the oscillation signal; and a low-pass filter which smooths the signal indicating the phase difference, and outputs the smoothed signal as a control voltage to the voltage control oscillator, wherein the low-pass filter is capable of switching time constants, and switches the time constants based on the frequency detection signal.

According to this configuration, time constants are switched in a locked state and an unlocked state to make it possible to change a response speed of the loop and to prevent switching by an erroneous determination.

The frequency detection circuit may include: a count unit which measures a frequency of the oscillation signal; and a determination unit which determines whether a measured value from the count unit falls within the predetermined range.

According to this configuration, since the count unit is a so-called frequency counter, the count unit can also be used as a frequency counter of a digital AFT (Automatic Fine Tuning; automatic frequency adjustment) device which is often arranged in a receiving apparatus, and the circuit area can be further reduced.

The count unit may periodically measure a frequency of the oscillation signal, and the determination unit may output a frequency detection signal indicating that the phase-locked loop circuit is in a locked state, in the case of determining that the frequency continuously falls within the predetermined range a predetermined number of times.

According to this configuration, not only prevention of an erroneous determination of a locked/unlocked state but also improvement of determination reliability can be achieved.

A receiving circuit according to the present invention may include: an amplification circuit which amplifies a video intermediate-frequency signal outputted from a tuner; a phase-locked loop circuit which synchronizes a phase of an oscillation signal with a phase of an output signal from the amplification circuit, and includes a voltage control oscillator which outputs the oscillation signal, a phase detection circuit which detects a phase difference between an output signal from the amplification circuit and the oscillation signal, and a low-pass filter which outputs a control voltage resulting from smoothing a signal indicating the detected phase difference to the voltage control oscillator; a synchronous detection circuit which synchronously detects the amplified video intermediate-frequency signal based on the oscillation signal, so as to output a video signal; a frequency detection circuit which measures a frequency of the oscillation signal from the voltage control oscillator and determines whether the frequency of the oscillation signal falls within a predetermined range including a predetermined video intermediate-frequency signal, based on the measured value, so as to output a frequency detection signal indicating whether the phase-locked loop circuit is in a locked state; an electric field intensity detection circuit which detects an electric field intensity of the video intermediate-frequency signal, and outputs an electric field intensity detection signal indicating an electric field intensity; and a modulation degree detection circuit which detects a degree of modulation of the video intermediate-frequency signal, and outputs a modulation degree detection signal indicating a degree of modulation, wherein the phase-locked loop circuit opens and closes a loop formed by the voltage control oscillator, the phase detector, and the low-pass filter based on the frequency detection signal, the electric field intensity detection signal, and the modulation degree detection signal, and maintains the control voltage obtained in a state in which an immediately previous loop is closed when the loop is opened.

According to this configuration, even though a degree of modulation is high or low, the oscillation signal having a slight error is always obtained as a reproduction carrier wave with reference to the frequency or phase of an original carrier wave, and the frequency detection circuit and the electric field intensity detection circuit do not make erroneous determinations. More specifically, an erroneous determination of a locked/unlocked state by overmodulation can be prevented. Furthermore, since the oscillation signal does not change depending on a video pattern, a degree of modulation, or a luminance level, a correct video signal can be obtained regardless of a video pattern. Since an electric field intensity is detected based on the correct video signal, a correct electric field intensity can also be obtained.

In the case where the frequency detection signal indicates that the phase-locked loop circuit is in a locked state, the electric field intensity detection signal indicates that the electric field intensity of the video intermediate-frequency signal is not less than a threshold value, and the modulation degree detection signal indicates that the video intermediate-frequency signal is in an overmodulated state indicating the modulation degree not less than a predetermined value, the phase-locked loop circuit may open the loop, and in the case otherwise, the phase-locked loop circuit may close the loop.

According to this configuration, since the frequency detection signal and the electric field intensity detection signal are correct more than those of a conventional configuration, opening/closing of the loop by the switch circuit can be realized without any error. The receiving circuit can stably output a video signal.

The low-pass filter may be capable of switching time constants, and when the frequency detection signal indicates that the phase-locked loop circuit is not in a locked state, or when the electric field intensity detection signal indicates that the electric field intensity of the video intermediate-frequency signal is weak indicating a threshold value or lower, the phase-locked loop circuit may decrease a time constant.

According to the configuration, since the frequency detection signal and the electric field detection signal are correct more than those of a conventional configuration, switching of a time constant can be appropriately performed without any error.

The frequency detection circuit may include: a frequency counter which periodically measures a frequency of the oscillation signal; and a determination unit which outputs a frequency detection signal indicating that the phase-locked loop circuit is in a locked state when a measured value from the frequency counter continuously falls within the predetermined range a predetermined number of times.

According to the configuration, the frequency detection circuit can stably correctly make a determination. In an analog comparator in a conventional lock detection circuit, a determination threshold value is affected by a change in temperature, a change in power supply voltage, and fluctuations in divergence of the circuit elements with respect to a reference voltage Vref. In contrast to this, in the frequency detection circuit included in the present invention, since a result indicating that the value falls within the predetermined range is digitally processed, the value is rarely changed depending on a change in temperature, a change in power supply voltage, and fluctuations in divergence of the circuit elements. For this reason, the frequency detection circuit can stably correctly realize the determination.

The receiving apparatus and the receiving method according to the present invention have the same units as described above and achieve the same effect as described above.

According to the present invention, even though a video signal is overmodulated, or even though a high-luminance image having a white pattern is used, an erroneous determined can be advantageously predetermined. Furthermore, a smoothing capacitor to determine a locked/unlocked state is made unnecessary, a circuit area can be reduced, or the number of pins which connect an external capacitor can be advantageously prevented from increasing. Furthermore, the frequency detection circuit is also used as a counter for the digital AFT device to make it possible to further reduce the circuit area.

### FURTHER INFORMATION ABOUT TECHNICAL BACKGROUND TO THIS APPLICATION

The disclosure of Japanese Patent Application No. 2005-378906(2005.12.28) filed on Dec. 28, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a video detection intermediate-frequency signal processing circuit which employs a conventional PLL synchronous detection scheme;

FIG. 2 is a block diagram showing a video detection intermediate-frequency signal processing circuit which employs a conventional sampling PLL synchronous detection scheme;

FIG. 3 is a diagram showing states of detection signals and PLL in respective operation modes in the configuration in FIG. 2;

FIG. 4 is a block diagram showing a configuration of a lock detection circuit 30;

FIGS. 5A to SC are waveform charts for explaining an operation of the lock detection circuit 30;

FIG. 6 is a block diagram showing a video intermediate-frequency signal processing circuit according to an embodiment of the present invention;

FIG. 7 is a block diagram of a configuration of a frequency detection circuit 33;

FIG. 8 is a circuit diagram showing a configuration of a hold circuit 54;

FIG. 9 is a timing chart showing timings of respective signal in the frequency detection circuit 33;

FIG. 10 is a diagram showing states of detection signals and PLL in respective operation modes in the configuration in FIG. 6;

FIG. 11 is a waveform chart for explaining a degree of modulation of a video detection output; and

FIG. 12 is a diagram showing relationships between detection signals and time constants of an LPF 26 in operation modes in the configuration in FIG. 6.

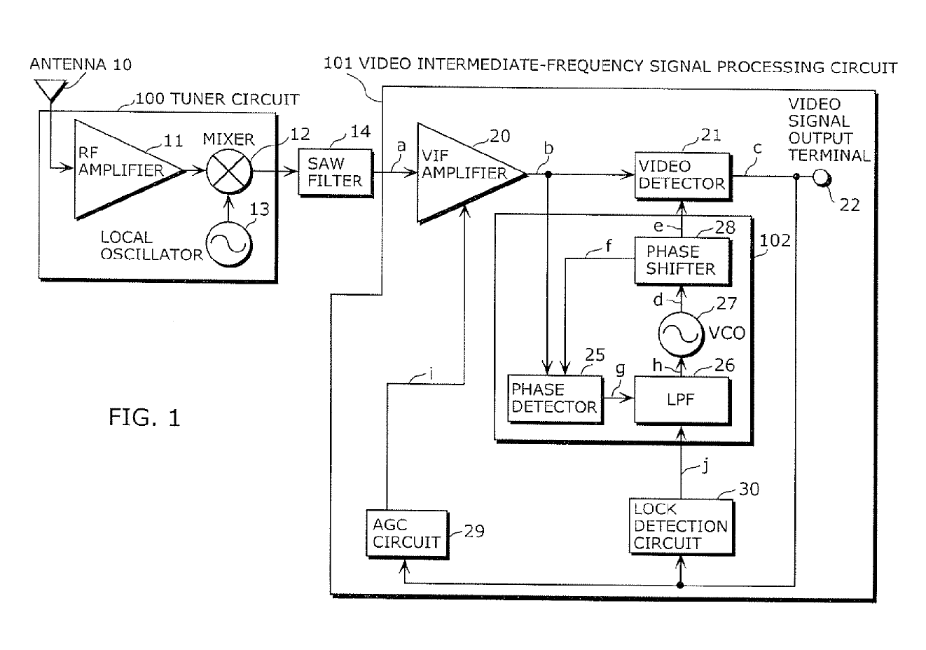

### DESCRIPTION OF THE PREFERRED EMBODIMENT

In a video intermediate-frequency signal processing circuit according to this embodiment, a determination of a locked/unlocked state of a PLL circuit 102 is performed based on an oscillation output d from a VCO 27 but a video detection output c. More specifically, it is determined whether a frequency of the oscillation output d from the VCO 27 falls within a range which is allowed as a video intermediate frequency. In this manner, even though a video signal is overmodulated, or even though a high-luminance image having a white pattern is used, an erroneous determination can be prevented, and a capacitor to smooth the video signal is made unnecessary. For this reason, a circuit area can be reduced.

An embodiment of the present invention will be described below with reference to the accompanying drawings.

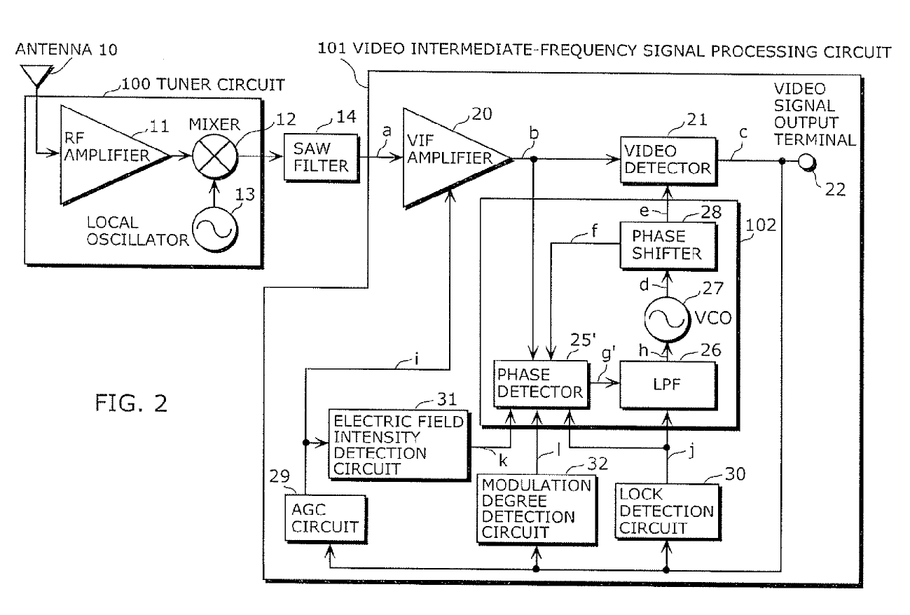

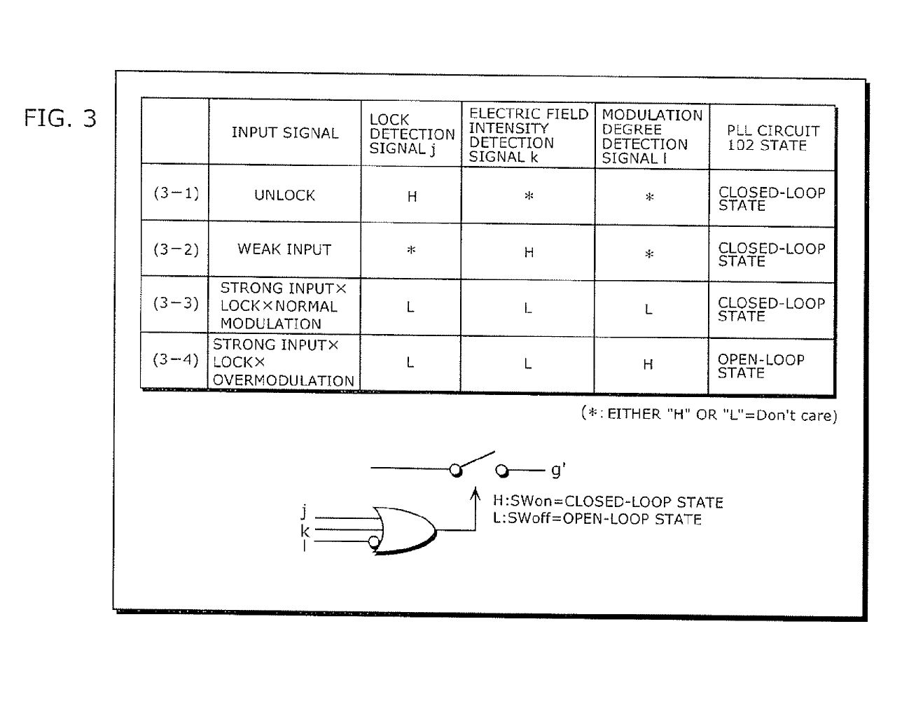

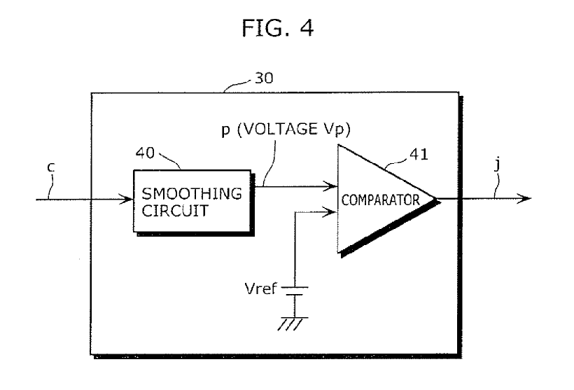

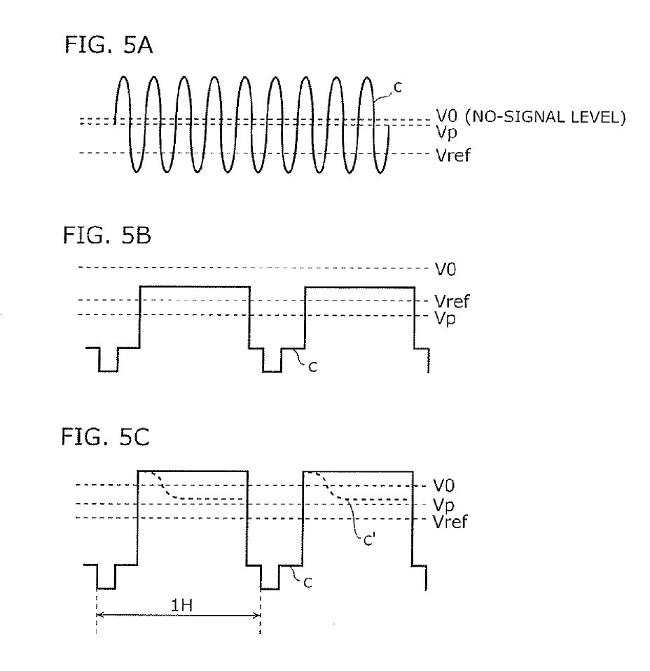

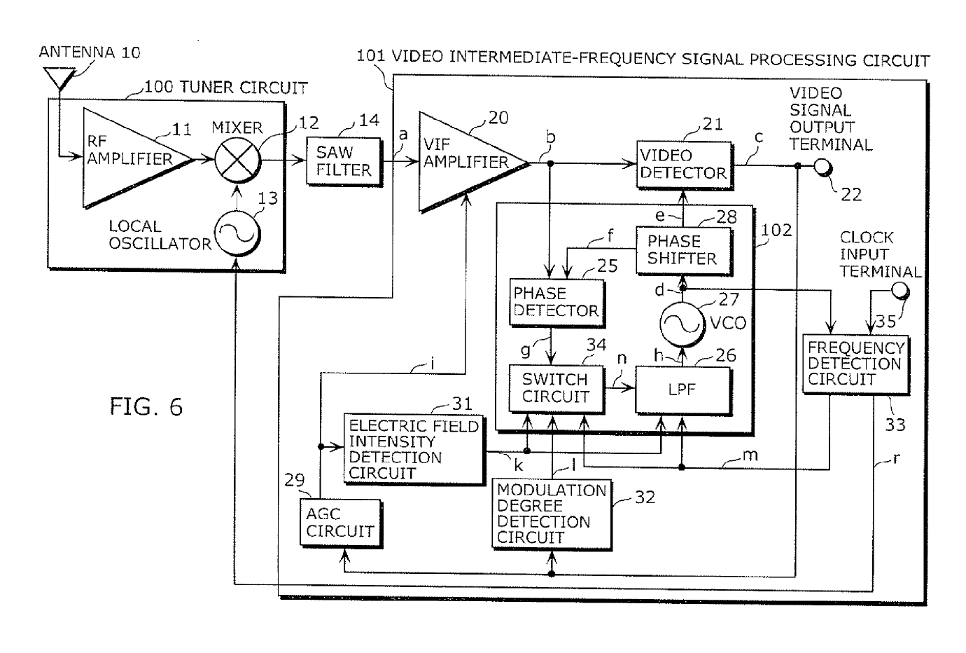

FIG. 6 is a block diagram showing a receiving apparatus including a video intermediate-frequency signal processing circuit according to an embodiment of the present invention. The same reference numerals as in FIG. 2 denote the same parts as in FIG. 6.

A frequency detection circuit 33 determines whether a frequency of the oscillation output d from the VCO 27 falls within a predetermined range (for example, 58.75 MHz ±200 kHz) (to be referred to as within a VIF band hereinafter) including a predetermined video intermediate frequency or out of the predetermined range to output a frequency detection signal m.

This frequency detection signal m indicates that the frequency falls within the VIF band, i.e., the PLL circuit 102 is in a locked state or an unlocked state. An inputted to the frequency detection circuit 33 may be the output d from the VCO 27, an output b from a VIF amplifier, or an output from a phase shifter.

A switch circuit 34 is newly arranged between a phase detector 25 and an LPF 26 and controls opening/closing of a switch based on an output l from a modulation degree detection circuit 32, an output k from an electric field intensity detection circuit 31, the output m from the frequency detection circuit 33. When the switch circuit 34 is in an off state, the PLL circuit 102 is in an open-loop 15 state, an output g from the phase detector 25 is not inputted to the LPF 26, and an output h from the LPF 26 is held at an immediately previous value. On the other hand, when the switch circuit 34 is turned on, the PLL circuit 102 is in an open-loop state, and the output g from the phase detector 25 is inputted to the LPF 26 signal n. This switch circuit 34 is arranged between the phase detector 25 and the LPF 26 in FIG. 6. However, when a current supply of the phase detector is turn on or off, the same effect as described above can be obtained.

Time constants of the LPF 26 are switched based on the output k from the electric field intensity detection circuit 31 and the output m from the frequency detection circuit 33.

An operation of the video intermediate-frequency signal processing circuit according to the present invention having the above configuration will be described below. Since configurations and functions except for the frequency detection circuit 33 and the PLL circuit 102 are the same as those in a conventional art, a description thereof will be omitted.

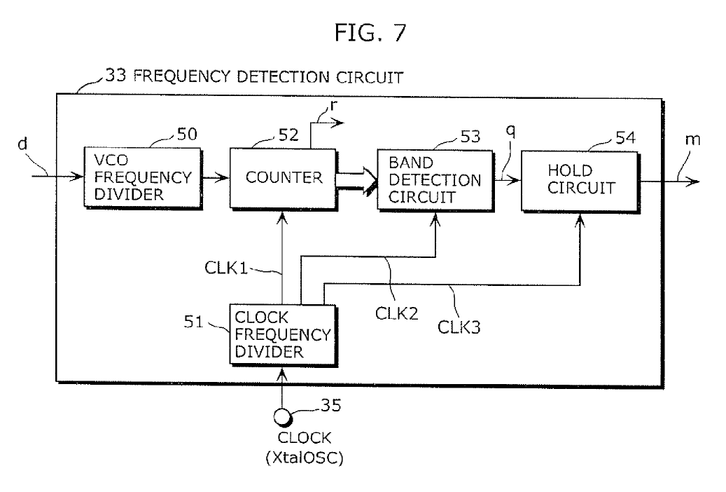

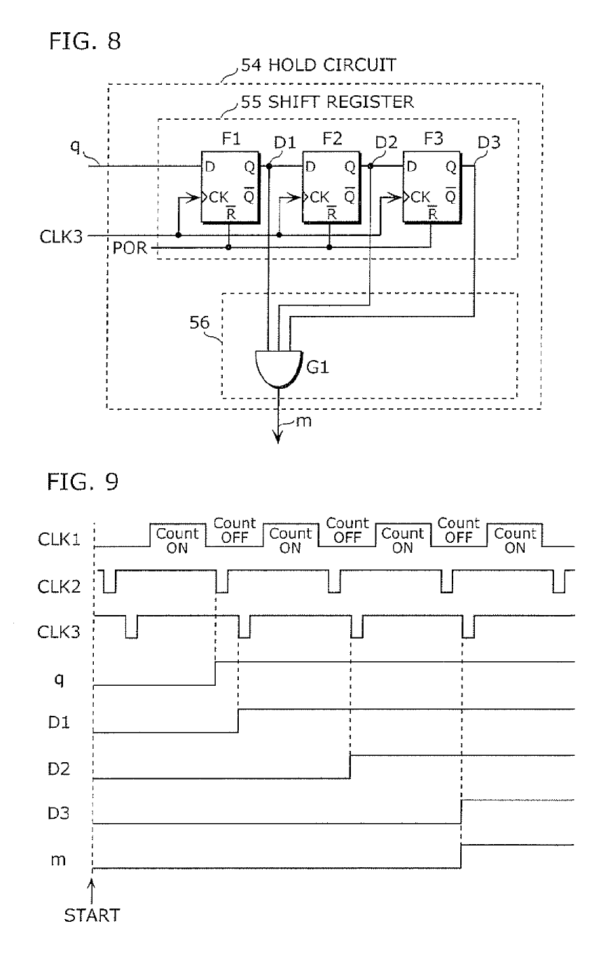

The frequency detection circuit 33 will be explained first. FIG. 7 shows an example of the frequency detection circuit 33. The frequency detection circuit 33 includes a VCO frequency divider 50, a clock frequency divider 51, a counter 52, a band detection circuit 53, and a hold circuit 54. The frequency detection signal m is connected to the switch circuit 34 and the LPF 26 in the PLL circuit 102. FIG. 8 is a circuit diagram showing the hold circuit 54 in detail. FIG. 9 is a timing chart showing timings of respective signals shown in FIGS. 7 and 8 when the frequency of the oscillation output d from the VCO 27 changes from a value falling out of the VIF band to a value falling within the VIF band.

The VCO frequency divider 50, the clock frequency divider 51, and the counter 52 in FIG. 7 function as a count unit which measures the frequency of the oscillation output d from the VCO 27 and correspond to frequency counters. The band detection circuit 53 and the hold circuit 54 both function as determination units which determine whether the measured value from the frequency counters falls within the VIF band to determine whether the PLL circuit 102 is in a locked state.

The oscillation output d from the VCO 27 is divided by the VCO frequency divider 50. Thereafter, a frequency of the oscillation output d is counted in a period determined by a cycle of an output signal CLK1 from the clock frequency divider 51. The frequency count is performed by a correct reference frequency, and in general, an oscillation frequency of a quartz oscillator Xta l OSC is used. As the oscillation frequencies, for example, 3.58 MHz and 4.00 MHz are selectively used depending on set manufacturers and tuner pack manufacturers. The frequency accuracy of the quartz oscillator Xtal OSC is relatively high, i.e., several kHz.

In the band detection circuit 53, depending on an output signal from the counter 52, it is determined whether a frequency of the oscillation output d from the VCO 27 falls within the VIF band or falls out of the VIF band. The band detection circuit 53 outputs the determined value to the hold circuit 54 each time an output signal CLK2 from the clock frequency divider 51 is inputted.

The hold circuit 54 includes a shift register 55 and a determination unit 56 as shown in FIG. 8. The shift register 55 includes flipflops F1 to F3, and the determination unit 56 includes a gate G1. In the shift register 55, results of the band detection circuit 53 which determines whether the oscillation output d from the VCO 27 falls within the VIF band are sequentially stored each time an output signal CLK3 from the clock frequency divider 51 is inputted, and a predetermined number of times which is set in advance (three times in this embodiment) is held. In the determination unit 56, output signals D1, D2, and D3 from the shift register 55 are inputted. Each time the result is stored in the shift register 55 the predetermined number of times, it is detected whether all the signals D1, D2, and D3 are determined as signals falling within the VIF band. When it is determined that all the signals fall within the VIF band, it is determined that an output is stable, and, as the frequency detection signal m, a signal indicating that the frequency of the oscillation output d from the VCO 27 falls within the VIF band is outputted each time the output signal CLK3 is inputted. More specifically, when the output signal d from the VCO 27 is unstable, if the frequency falls out of the VIF band at least once the predetermined number of times, a signal indicating that the frequency falls out of the VIF band is outputted as the frequency detection signal m in the period in which the detection results are stored the predetermined number of time. In this manner, the reliability of determination can be improved.

When the PLL circuit 102 is locked, a frequency of the oscillation output d from the VCO 27 is synchronized with a frequency of a VIF signal, i.e., a video intermediate frequency. For this reason, the output signal from the frequency detection circuit 33 determines that the frequency falls within the band. This determination is always correct when the PLL circuit 102 is locked regardless of the degree of modulation of the video detection output c and a luminance level.

On the other hand, when a power supply is turned on, or when a frequency of the VIF input signal considerably deviates, the PLL circuit 102 is set in an unlocked state. In the unlocked state, a frequency of the oscillation output d from the VCO 27 is not a predetermined video intermediate frequency, and is unstable in a wide frequency band. Therefore, the frequency detection circuit 51 outputs a detection result indicating that the frequency falls out of the VIF band as the frequency detection signal m because the oscillation output d from the VCO 27 is unstable.

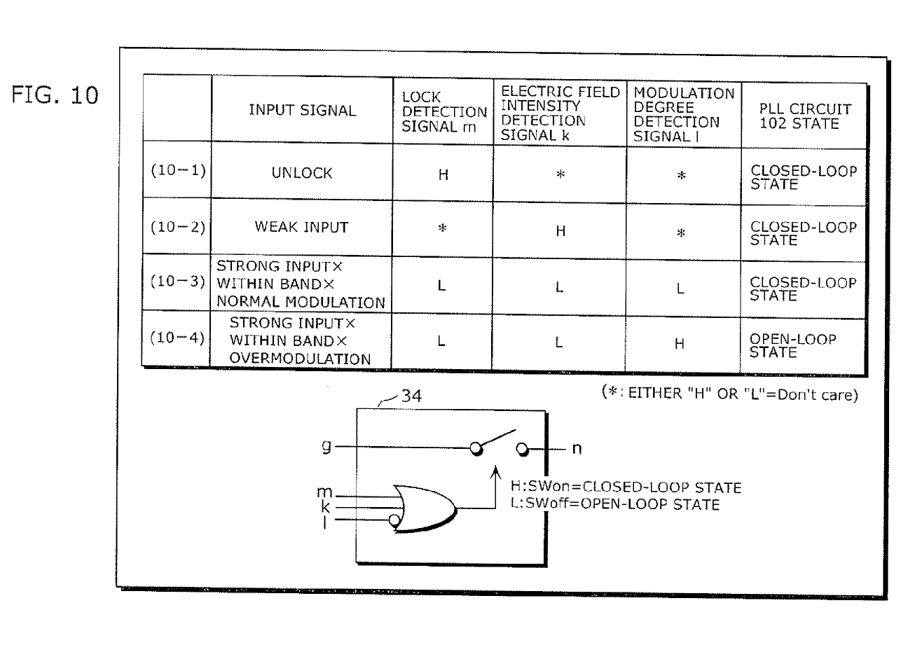

FIG. 10 shows states of detection signals m, k, and l and the PLL circuit 102 in respective operation modes in the video intermediate-frequency signal processing circuit 101 according to the present invention.

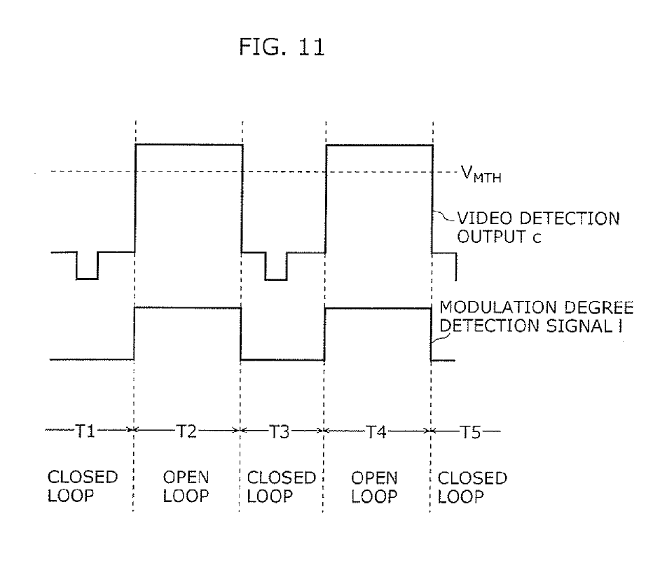

When the VIF signal is in an intermediate/strong electric field input state, and when the PLL circuit 102 is locked, the PLL circuit 102 repeatedly set in a closed-loop state and an open-loop state depending on the degree of modulation of the VIF signal (10-3 and 10-4). More specifically, in a period in which the degree of modulation and a luminance level of a video signal are high (periods T2 and T4 in FIG. 11), the switch circuit 34 is turned off, the PLL circuit 102 is set in the open-loop state, and the output d from the VCO 27 is held at a frequency and a phase obtained in an immediately previous open-loop state (10-4). On the other hand, in a period in which the luminance level of the video signal is low (periods T1, T3, and T5 in FIG. 11), the switch circuit 34 is turned on, and the PLL circuit 102 is set in an open-loop state (10-3). Thereforer even though the degree of modulation is high or low, a carrier wave having a slight error is always obtained with reference to the frequency or phase of an original carrier wave. Since the oscillation output d from the VCO 27 does not change depending on a video pattern, in particular, a degree of modulation or a luminance level, the frequency detection circuit and the electric field density detection circuit do not erroneously perform determinations, and a correct video detection output can be obtained regardless of a video pattern. Therefore, the problem (1) caused by overmodulation does not occur.

When the VIF signal is set in a weak electric field input state (10-2) or falls out of the VIF band (10-1), the switch circuit 34 is turned on, and the PLL circuit 102 is in a closed-loop state.

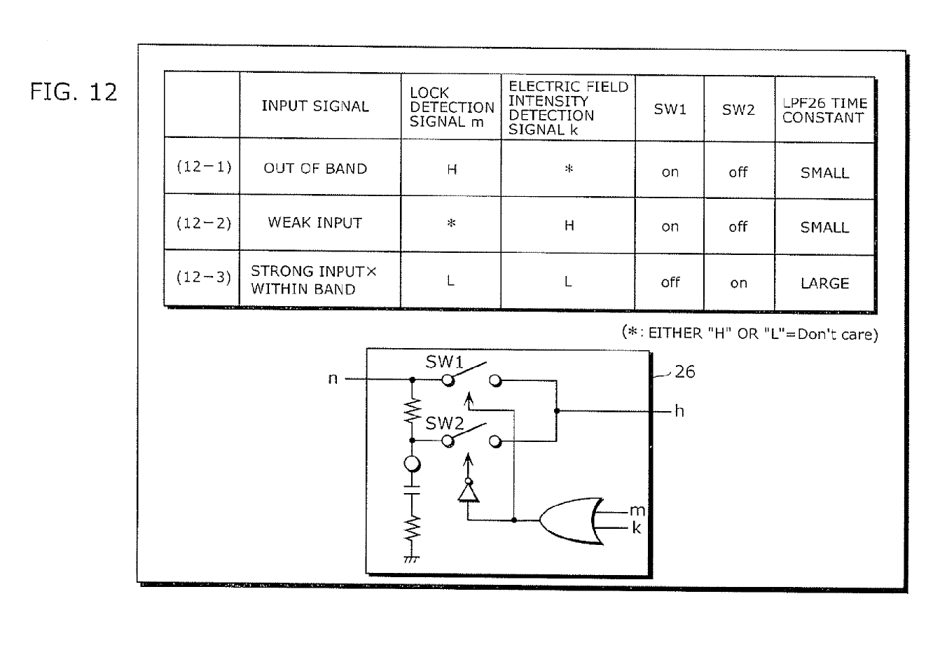

A configuration of the LPF 26 is shown in FIG. 12. Switches SW1 and SW2 are turned on/off based on the electric field intensity detection signal k and the frequency detection signal m to switch time constants. When the VIF signal is set in the weak electric field input state (12-2) or falls out of the VIF band (12-1), the switch SW1 is turned on, and the switch SW2 is turned off, so that a time constant of the LPF 26 is made smaller than that in a normal state. The PLL circuit 102 is set in a closed-loop state, and the time constant of the LPF is decreased to increase a response speed and to widen a capture range of the PLL. On the other hand, in the locked state, i.e., in the strong/intermediate electric field input state, the switch SW1 is turned off, and the switch SW2 is turned on to increase the time constant and to reduce a response speed, so that control is performed to prevent the LPF from easily responding to noise, phase distortion, or the like. Therefore, in the switching operation of time constants of the LPS, an erroneous determination caused by a video pattern is not performed, and the problem (2) caused by a high-luminance video pattern in a normal modulation state can be avoided. Unlike a conventional reference voltage Vref, since a threshold value of a frequency band rarely changes depending on a change in temperature, a change in power supply voltage, and fluctuations in deviation of circuit elements, the threshold value is easily set,

The counter 52 can also be used as a counter used in a digital AFT device. In a general television signal receiver, an AFT circuit which controls an oscillation frequency of the local oscillator 13 of a tuner such that a video intermediate frequency correctly becomes a predetermined value (for example 58.75 MHz) is used. Although the frequency of the video intermediate frequency signal must be detected, in recent years, a method of controlling an oscillation frequency of the local oscillator 13 depending on a signal r obtained by counting the frequency of an output from the VCO 27 is known (for example, Japanese Laid-Open Patent Application No. 10-276111).

When the counter 52 according to the present invention is also used as the counter in the AFT device, only the band detection circuit 53 and the hold circuit 54 may be arranged as new circuits, and a circuit scale can be made smaller than that of the smoothing circuit 40 or the comparator 41 in the conventional art. In particular, unlike in the conventional art, the smoothing circuit 40 does not require a large capacitor, and an external terminal for connecting an external capacitor is not necessary. When the predetermined range determined as the VIF band is equal to an operation range of the AFT, the band detection circuit 53 becomes simpler. Therefore, the problem (3) can also be solved,

As described above, in the video intermediate-frequency signal processing circuit according to the present invention, a state of the PLL circuit 102 is switched to a closed-loop state or an open-loop state depending on the frequency detection signal m, the electric field intensity detection signal k, and the modulation degree detection signal l. Since the frequency detection circuit 33 and the electric field intensity detection circuit 31 do not erroneous determinations due to a video pattern, in particular, a degree of modulation or a luminance level, video detection can be correctly performed to an overmodulated video intermediate frequency signal. Furthermore, the counter 52 is also used as the counter circuit of the digital AFT device, so that a circuit scale can be reduced.

The receiving circuit in FIG. 6 is typically built in a television tuner pack, and mounted on a receiving apparatus such as a television set. The video intermediate-frequency signal processing circuit 101 is manufactured as a 1-chip LSI. In particular, the video intermediate-frequency signal processing circuit 101 is suitable for a television tuner pack which is reduced in size in recent years.

The receiving circuit according to the present invention is useful to a circuit which uses an overmodulated input signal and demodulates an amplitude modulation wave, in particular, a demodulation circuit for a video intermediate frequency signal, a television tuner pack, and a television set.

Although only some exemplary embodiments of this invention have been described in detail above, those skilled in the art will readily appreciate that many modifications are possible in the exemplary embodiments without materiatly departing from the novel teachings and advantages of this invention. Accordingly, all such modifications are intended to be included within the scope of this invention.

What is claimed is:

1. A receiving circuit comprising:
a phase-locked loop circuit which outputs an oscillation signal synchronized with a phase of a modulation signal modulated by a video signal;
a video signal detector which synchronously detects the modulation signal using the oscillation signal, so as to output the video signal; and
a frequency detection circuit which determines whether or not the frequency of the oscillation signal Falls within a predetermined range to output a frequency detection signal that indicates whether or not the phase-locked loop circuit is in a locked state,
wherein the phase-locked loop circuit is controlled by the frequency detection signal.

2. The receiving circuit according to claim 1,
wherein the phase-locked loop circuit includes:
a voltage control oscillator which outputs the oscillation signal;
a phase detector which outputs a signal indicating a phase difference between the modulation signal and the oscillation signal;
a low-pass filter which smooths the signal indicating the phase difference, and outputs the smoothed signal as a control voltage to the voltage control oscillator; and
a switch circuit which opens and closes a loop formed by the voltage control oscillator, the phase detector, and the low-pass filter,
wherein the switch circuit opens and closes the loop based on the frequency detection signal.

3. The receiving circuit according to claim 1,
wherein the phase-locked loop circuit includes:
a voltage control oscillator which outputs the oscillation signal;
a phase detector which detects a phase difference between the modulation signal and the oscillation signal; and
a low-pass filter which smooths the signal indicating the phase difference, and outputs the smoothed signal as a control voltage to the voltage control oscillator,
wherein the low-pass filter is capable of switching time constants, and switches the time constants based on the frequency detection signal.

4. The receiving circuit according to claim 1,
wherein the frequency detection circuit includes:
a count unit operable to measure a frequency of the oscillation signal; and
a determination unit operable to determine whether a measured value from the count unit falls within the predetermined range.

5. The receiving circuit according to claim 4,
wherein the count unit is operable to periodically measure a frequency of the oscillation signals and
the determination unit is operable to output a frequency detection signal indicating that the phase-locked loop circuit is in a locked state, in the case of determining that the frequency continuously falls within the predetermined range a predetermined number of times.

6. A receiving circuit comprising:
an amplification circuit which amplifies a video intermediate-frequency signal outputted from a tuner;
a phase-locked loop circuit which synchronizes a phase of an oscillation signal with a phase of an output signal from the amplification circuit, and includes a voltage control oscillator which outputs the oscillation signal, a phase detection circuit which detects a phase difference between an output signal from the amplification circuit and the oscillation signal, and a low-pass filter which outputs a control voltage resulting from smoothing a signal indicating the detected phase difference to the voltage control oscillator;
a synchronous detection circuit which synchronously detects the amplified video intermediate-frequency signal based on the oscillation signal, so as to output a video signal;
a frequency detection circuit which measures a frequency of the oscillation signal from the voltage control oscillator and determines whether the frequency of the oscillation signal falls within a predetermined range including a predetermined video intermediate-frequency signal, based on the measured value, so as to output a frequency detection signal indicating whether the phase-locked loop circuit is in a locked state;
an electric field intensity detection circuit which detects an electric field intensity of the video intermediate-frequency signal, and outputs an electric field intensity detection signal indicating an electric field intensity; and
a modulation degree detection circuit which detects a degree of modulation of the video intermediate-frequency signal, and outputs a modulation degree detection signal indicating a degree of modulation,
wherein the phase-locked loop circuit opens and closes a loop formed by the voltage control oscillator, the phase detector, and the low-pass filter based on the frequency detection signal, the electric field intensity detection signal, and the modulation degree detection signal, and maintains the control voltage obtained in a state in which an immediately previous loop is closed when the loop is opened.

7. The receiving circuit according to claim 6,
wherein, in the case where the frequency detection signal indicates that the phase-locked loop circuit is in a locked state, the electric field intensity detection signal indicates that the electric field intensity of the video intermediate-frequency signal is not less than a threshold value, and the modulation degree detection signal indicates that the video intermediate-frequency signal is in an overmodulated state indicating the modulation degree not less than a predetermined value, the phase-locked loop circuit opens the loop, and in the case otherwise, the phase-locked loop circuit closes the loop.

8. The receiving circuit according to claim 6, wherein
the low-pass filter is capable of switching time constants, and
when the frequency detection signal indicates that the phase-locked loop circuit is not in a locked state, or when the electric field intensity detection signal indicates that the electric field intensity of the video intermediate-frequency signal is weak indicating a threshold value or lower, the phase-locked loop circuit decreases a time constant.

9. The receiving circuit according to claim 6,
wherein the frequency detection circuit includes:
a frequency counter which periodically measures a frequency of the oscillation signal; and
a determination unit operable to output a frequency detection signal indicating that the phase-locked loop circuit is in a locked state when a measured value from the frequency counter continuously falls within the predetermined range a predetermined number of times.

10. A receiving apparatus equipped with a receiving circuit,
wherein the receiving circuit includes:
a phase-locked loop circuit which outputs an oscillation signal synchronized with a phase of a modulation signal modulated by a video signal;
a video signal detector which synchronously detects the modulation signal using the oscillation signal, so as to output the video signal; and
a frequency detection circuit which determines whether the frequency of the oscillation signal falls within a predetermined range, so as to output a frequency detection signal indicating that the phase-locked loop circuit is in a locked state,
wherein the phase-locked loop circuit is controlled by the frequency detection signal.

11. A receiving method for use in a receiving circuit equipped with a phase-locked loop circuit which outputs an oscillation signal synchronized with a phase of a modulation signal modulated by a video signal, and a video signal detector which synchronously detects the modulation signal using the oscillation signal, so as to output the video signal, said method comprising:
determining whether or not the frequency of the oscillation signal falls within a predetermined range so as to output a frequency detection signal indicating whether or not the phase-locked loop circuit is in a locked state, and
controlling the phase-locked loop circuit using the frequency detection signal.
